(19) United States
(12) Patent Application Publication
(10) Pub. No.: US 2017/0253377 A1
(43) Pub. Date: Sep. 7, 2017

(54) STACKABLE CONTAINER

(71) Applicants: Jack J. Mitrey, Powell, OH (US); Preston Wayne Schwartz, Peoria, AZ (US)

(72) Inventors: Jack J. Mitrey, Powell, OH (US); Preston Wayne Schwartz, Peoria, AZ (US)

(21) Appl. No.: 15/062,024

(22) Filed: Mar. 4, 2016

(51) Int. Cl. B65D 21/02; B65G 57/16

(52) U.S. Cl. CPC B65D 21/0233; B65G 57/165

(57) ABSTRACT

A stackable container comprising a bottom surface; a top ridge; a continuous tapered side wall extending upwardly from the bottom surface to the top ridge, wherein the continuous tapered side wall has an inner surface and an outer surface; and a number of wedged elements positioned on the tapered side wall, each of the number of wedged elements positionally spaced equidistant around the outer surface of the tapered side wall.

### CROSS-REFERENCE TO RELATED APPLICATIONS

N/A

### BACKGROUND OF THE INVENTION

1. Field of the Invention

The present invention relates to containers, and more particularly stackable containers.

2. Description of Related Art

In the art of stackable containers, such as buckets, there are many disadvantages. Currently, after stacking or nesting multiple containers in a stack, it is very difficult to remove each container from the stack, as often the containers get stuck together. Another disadvantage is that the height of the stack is often higher than necessary due to surface ridges found below the top of the bucket. This configuration only allows a partial nest between buckets. Consequently, there is a need for a stackable container configuration that prevents containers from getting stuck together while allowing a full nested position lowering the stack height relative to the number of containers.

### BRIEF SUMMARY OF THE INVENTION

In one embodiment of the present invention a stackable container is provided, comprising a bottom surface; a top ridge; a continuous tapered side wall extending upwardly from the bottom surface to the top ridge, wherein the continuous tapered side wall has an inner surface and an outer surface; and a number of wedged elements positioned on the tapered side wall, each of the number of wedged elements positionally spaced equidistant around the outer surface of the tapered side wall.

In one embodiment, the number of wedged each comprise a front surface, a top surface, a bottom surface, a back surface, and a pair of tapered side surfaces. In one embodiment, the top surface is flush with the top ridge and the back surface is flush with the outer surface. In another embodiment, the stackable container further comprises a stacking ridge located below the top ridge, wherein the stacking ridge includes a flanged surface. In one embodiment, the top surface is flush with the flanged surface and the back surface is flush with the outer surface. In yet another embodiment, the number of wedged elements is between four and six.

In one embodiment, the pair tapering side surfaces has a first thickness between 1/16″ and ⅛″, wherein the first thickness is defined where the top surface meets the pair of tapering side surfaces. In one embodiment, the pair tapering side surfaces has a second thickness, wherein the second thickness is defined where the bottom surface meets the pair of tapering side surfaces such that the front surface is flush with the outer surface of the container at the second thickness. In another embodiment, the front surface has a length and a width, wherein the length is between 1½″ and 2″, and the width is 1″. In yet another embodiment, the number of wedged elements prevents the stackable container from becoming stuck inside a second stackable container when the stackable container is nested inside the second stackable container, such that the number of wedged elements breaks the seal between the nested stackable container and second stackable container, allowing the stackable container and the second stackable container to be separated easily without the use of a tool.

In one embodiment, the stackable container is a cylindrical bucket. In one embodiment, the cylindrical bucket is a 5 gallon plastic bucket, constructed from a high-density polyethylene (HDPE). In another embodiment, the number of wedged elements are provided into a manufacturing mold for the stackable container, creating one integral unit. In yet another embodiment, the stackable container is constructed from a shape selected from the group of a cylinder, a square, a rectangular, an oval, or combination thereof.

In another aspect to the invention, a method is providing comprising steps: (a) providing a first container comprising a first bottom surface, a first top ridge, a first continuous tapered side wall extending upwardly from the first bottom surface to the first top ridge, wherein the first continuous tapered side wall has a first inner surface and a first outer surface, and a first number of wedged elements positioned on the first tapered side wall, each of the first number of wedged elements positionally spaced equidistant around the first outer surface of the first tapered side wall; (b) providing a second container comprising a second bottom surface, a second top ridge, a second continuous tapered side wall extending upwardly from the second bottom surface to the second top ridge, wherein the second continuous tapered side wall has a second inner surface and a second outer surface, and a second number of wedged elements positioned on the second tapered side wall, each of the second number of wedged elements positionally spaced equidistant around the second outer surface of the second tapered side wall; and (c) nesting the second container inside the first container such that the first number of wedged elements are engaged with the second outer surface.

In one embodiment, in step (c), the first number of wedged elements breaks the seal between the nested first and second, allowing the first and second containers to be separated easily without the use of a tool.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1A is a perspective view of a stackable container according to an embodiment of the present invention.

FIG. 1B is a detailed view of the stackable container of FIG. 1A.

FIG. 2 is a perspective view of a stackable container according to an embodiment of the present invention.

FIGS. 3A-B are perspective views of a method of stacking stackable containers according to an embodiment of the present invention.

FIG. 4 is a perspective view of a stackable container according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a stackable container.

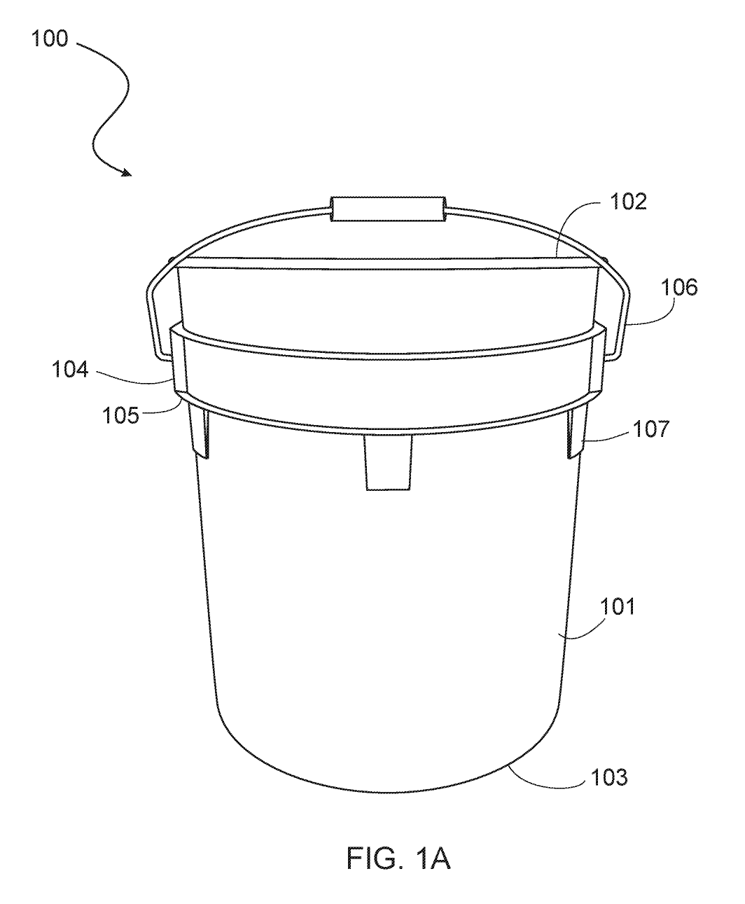

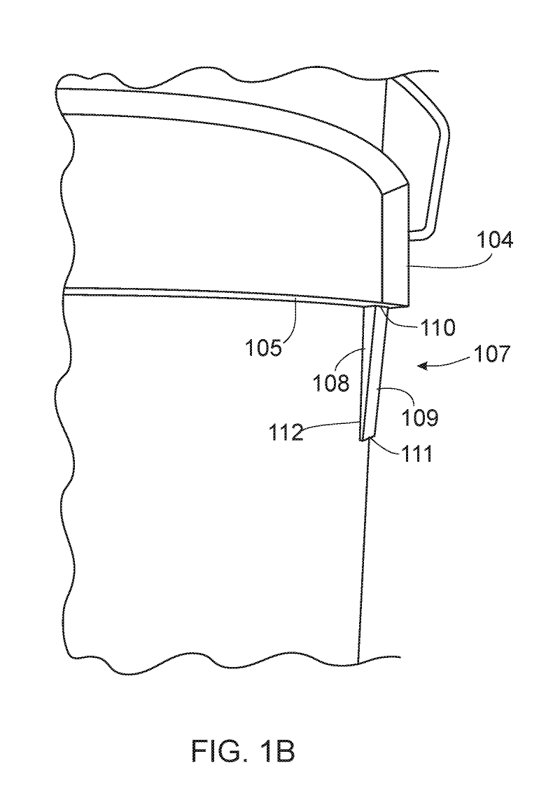

FIG. 1A is a perspective view of a stackable container 100 according to an embodiment of the present invention. Referring now to FIG. 1A, the stackable container comprises a tapered side wall 101, a top ridge 102, a bottom surface 103, a stacking ridge 104, and handle 106. The tapered side wall has an outer surface and an inner surface extending upwardly to the top ridge. The stacking ridge is located below the top ridge and includes a flanged surface 105. In some embodiments, the bottom surface and top ridge have a circular shape and the stackable container is a bucket. In this embodiment, the tapered side wall is such that the top ridge has a larger diameter than the bottom surface. The bucket illustrated including the referenced elements above, is a standard 5 gallon or 20 quarts plastic bucket, constructed from a high-density polyethylene (HDPE), generally provided by home improvement stores, and is used for storing liquids, mixing paints, topsoil, or other purposes. As well known in the art, the bucket is designed to be stacked with similar buckets. Presently, one bucket will nest inside a second bucket such that the top ridge of the first bucket will abut the flanged surface of the second bucket. This practice is usually repeated with several buckets, forming a stack of buckets. This is useful for space saving either during travel or storage. However, when disassembling the stack, or removing one bucket from the stack, often the buckets get stuck making this process difficult. This can be contributed to material expansion or shrinking during environmental conditions, a vacuum effect, or moisture in between two nested buckets, sealing the nested buckets together. When this occurs, often it requires tools or compressed air forced between the buckets to separate nested buckets that are stuck together.

It is a particular advantage of the present invention to provide a number of wedged elements 107 on the outer surface of the tapered side wall. The wedged elements are positioned around the tapered side wall, such that the wedged elements are equally spaced. There are preferably four to six wedged elements, although it is understood that the number of wedged elements may vary without departing from the spirit of the invention. The wedged elements are an improvement to existing containers and buckets, and prevent nesting buckets from becoming stuck together, and more specifically the wedged elements break the seal between nested buckets, allowing them to be separated easily without the use of tools, or other methods.

FIG. 1B is a detailed view of the stackable container of FIG. 1A. Referring now to FIG. 1B, a wedged element 107 is illustrated. The wedged element comprises a pair of tapering side surfaces 108, one side surface located on each side of a front surface 109. The wedged element further comprises a top surface 110, a bottom surface 111, and a back surface 112. In some embodiments, the wedged element is positioned flush with the bottom of a stacking ridge 104, and more specifically the top surface abuts a flanged surface 105 of the stacking ridge. Likewise, the back surface is positioned flush with the outer surface of the container. The thickness of the wedged element where the top surface meets the tapering side surfaces is preferably between 1/16″-⅛″. The thickness decreases until the bottom surface, wherein the wedged element is flush with the container. The thickness of the wedged element is a critical aspect to the invention. A thicker wedged element allows less suction between stacked or nested containers, making it easier to separate containers when desired. However, as the thickness increases the stack height of the containers increases as well, decreasing storage space and limiting the amount of containers nested in a single stack. Therefore, it is a particular advantage of the present invention to provide a thickness which allows the separation of nested containers while not increasing, or increasing the stack height. The previously mentioned dimensions of the wedged element accomplishes this goal. The length of the front surface is preferably 1½″-2″, and the width is approximately 1″. A narrow width can compromise the structural integrity of the wedged element and may lead to damage. However, it is understood that the width may be modified, wherein the modification are within the scope of the invention are may vary depending on the overall size of the container. The wedged element is preferably constructed of plastic and provided into the manufacturing mold for the container, creating one integral unit with the number of wedged elements. In alternative embodiments, the number of wedged elements may be added to each container after the container is manufactured as an aftermarket product. The number of wedged elements may be attached to the container with any suitable known method known in the art, including but not limited to mounting hardware, or adhesives.

In some embodiments, the size of the number of wedged elements are relative to the container size and capacity. In other embodiments, the shape of the number of wedged elements may vary. For instance, although the number of wedged elements are illustrated as generally rectangular with two parallel tapering side surfaces, it is understood that the two tapering side surfaces may come to a point at the bottom surface forming a triangle shape. In a similar sense, the shape of the wedged element may vary without departing from the scope and spirit of the invention.

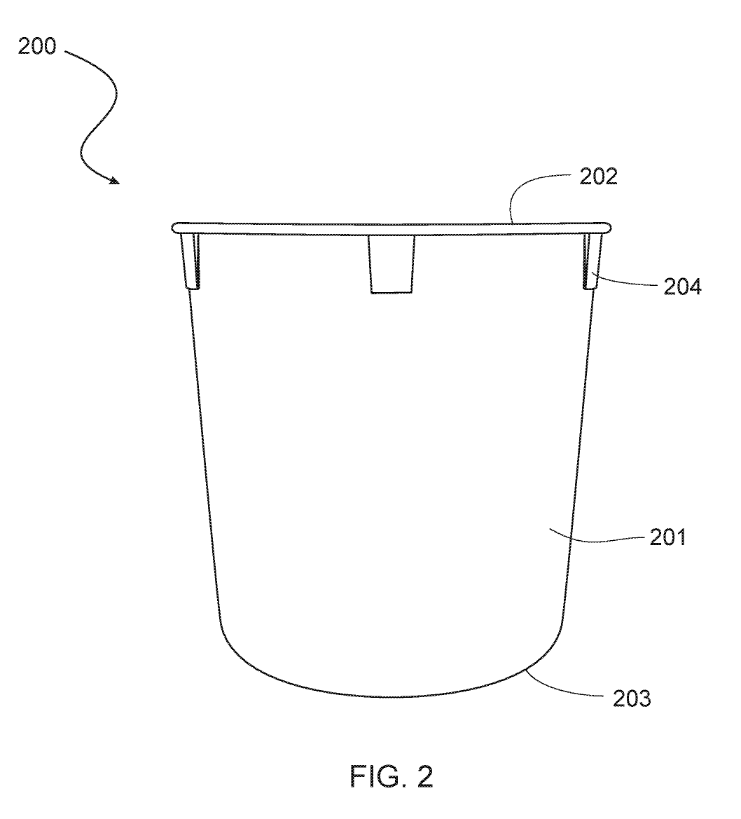

FIG. 2 is a perspective view of a stackable container 200 according to an embodiment of the present invention. Now referring to FIG. 2, the stackable container is illustrated, comprising a tapered side wall 201, a top ridge 202, and a bottom surface 203. The tapered side wall has an outer surface and an inner surface extending upwardly to the top ridge. The stackable container further comprises a number of wedged elements 204 on the outer surface of the tapered side wall. The wedged elements are positioned around the tapered side wall, such that the wedged elements are equally spaced. There are preferably four to six wedged elements, although it is understood that the number of wedged elements may vary without departing from the spirit of the invention. The wedged elements are an improvement to existing containers and buckets, and prevent nesting buckets from becoming stuck together, and more specifically the wedged elements break the seal between nested buckets, allowing them to be separated easily without the use of tools, or other methods. In the present embodiment, the number of wedged elements are located just under the top ridge. In some embodiments, the number of wedged elements are flush with the top ridge. This location is a particular advantage of the present invention, as this arrangement of wedged elements decreases the stack height when nesting two or more containers, increasing the amount of containers that may be stacked in a single stack improving storage space.

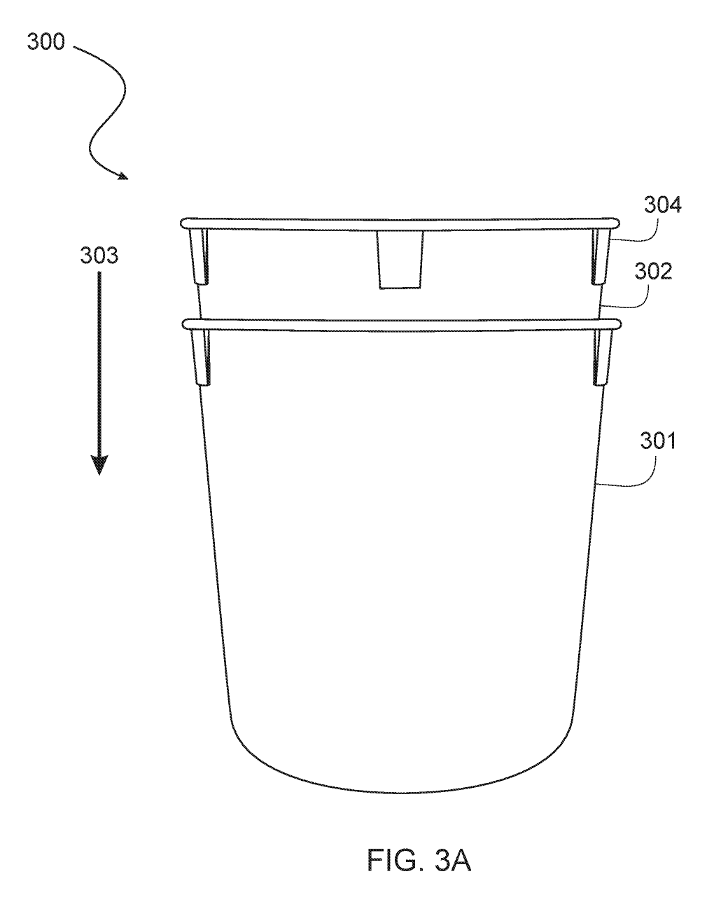

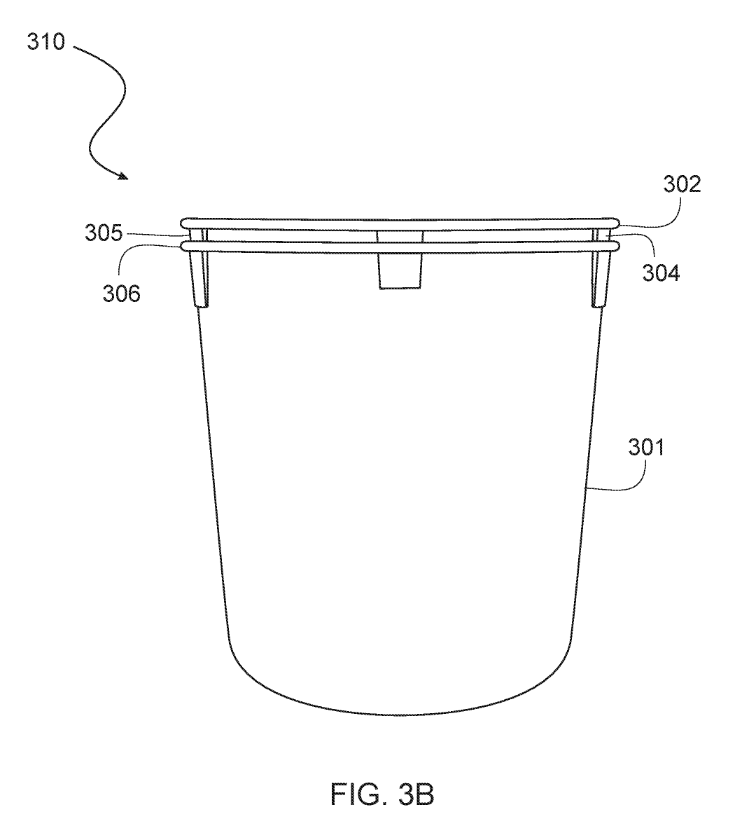

FIGS. 3A-B are perspective views of a method of stacking stackable containers 300/310 according to an embodiment of the present invention. FIGS. 3A-B illustrate two stackable containers 301 and 302 nested in a stack. Referring now to FIG. 3A, an operator may stack two or more similar containers by placing a second container 302 inside a first container 301 in the direction of 303, as well known in the art. FIG. 3B illustrates the second container completely nested in the first container. As previously mentioned, a number of wedged elements 304 prevents the nested containers from getting stuck allowing an ease of removal.

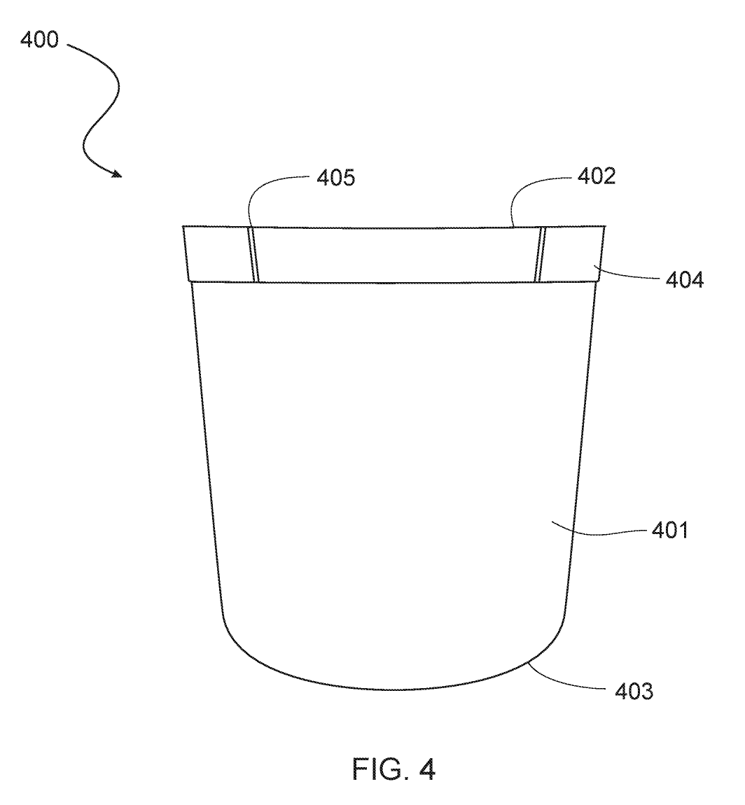

FIG. 4 is a perspective view of a stackable container 400 according to an embodiment of the present invention. Now referring to FIG. 4, the stackable container is illustrated comprising a tapered side wall 401, a top surface 402, a bottom surface 403, and a single continuous ringed wedged element 404. The tapered side wall has an outer surface and an inner surface extending upwardly to the top surface. In this embodiment, the top surface is also the top surface of the wedged element forming the container lip. This embodiment functions similarly to the previsions embodiments, however the number of wedged elements have been replaced with the single continuous ringed wedged element. The continuous ringed wedged element encircles the entire container. This embodiment offers a variation that may be more desirable during manufacturing. In some embodiment, the stackable container comprises at least one channel 405. The at least one channel allows airflow between nested containers preventing them from sticking together. This airflow is critical when removing nested containers, and specifically the at least one channel allows air to escape preventing a suction effect between the nested containers at the contact area, i.e. the single continuous ringed wedged element. The number of channels and the depth of the channels may be modified to discover optimum ranges by routine skill in the art.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, although cylindrical containers are illustrated it is understood that the inventive concept may be applied to a containers of any shape including but not limited to square, rectangular, oval, or combination thereof.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1. A system of stackable containers comprising:
a first container having a first bottom surface, a first top ridge, a first continuous tapered side wall extending upwardly from the bottom surface to the first top ridge, wherein the first continuous tapered side wall has a first inner surface and a first outer surface; and a first plurality of wedged elements positioned on the first continuous tapered side wall, wherein each of the first plurality of wedged elements comprise a first front surface, a first top surface, a first bottom surface, a first back surface, and a first pair of tapered side surfaces; and
a second container having a second top ridge and a second inner surface, wherein the first container is nested in the second container and each of the first front surfaces of the first plurality of wedged elements touch the second top ridge and second inner surface such that the first plurality of wedged elements prevent the first container from becoming stuck in the second container such that separating the first container from the second container may be performed without a tool.

2. (canceled)

3. The system of stackable containers of claim 1, wherein the first top surface is flush with the first top ridge and the first back surface is flush with the first outer surface.

4. The system of stackable containers of claim 1, wherein the first container further comprises a stacking ridge located below the fit top ridge, wherein the stacking ridge includes a flanged surface.

5. The system of stackable containers of claim 4, wherein the first top surface is flush with the flanged surface and the first back surface is flush with the first outer surface.

6. (canceled)

7. The system of stackable containers of claim 1, wherein the first pair tapering side surfaces has a first thickness between 1/16″ and ⅛″, wherein the first thickness is defined where the first top surface meets the first pair of tapering side surfaces.

8. The system of stackable containers of claim 7, wherein the first pair tapering side surfaces has a second thickness, wherein the second thickness is defined where the first bottom surface meets the first pair of tapering side surfaces such that the first front surface is flush with the outer surface of the stackable container at the second thickness.

9. The system of stackable containers of claim 8, wherein the first front surface has a length and a width, wherein the length is between 1½″ and 2″, and the width is 1″.

10. (canceled)

11. (canceled)

12. The system of stackable containers of claim 1, wherein the first and second containers are cylindrical 5 gallon plastic buckets, constructed from a high-density polyethylene (HDPE).

13. The system of stackable containers of claim 1, wherein the first plurality of wedged elements are provided into a manufacturing mold for the first container, creating one integral unit.

14. (canceled)

15. A method comprising steps:
(a) providing a first container comprising a first bottom surface, a first top ridge, a first continuous tapered side wall extending upwardly from the first bottom surface to the first top ridge, wherein the first continuous tapered side wall has a first inner surface and a first outer surface, and a first number of wedged elements positioned on the first tapered side wall, each of the first number of wedged elements positionally spaced equidistant around the first outer surface of the first tapered side wall;
(b) providing a second container comprising a second bottom surface, a second top ridge, a second continuous tapered side wall extending upwardly from the second bottom surface to the second top ridge, wherein the second continuous tapered side wall has a second inner surface and a second outer surface, and a second number of wedged elements positioned on the second tapered side wall, each of the second number of wedged elements positionally spaced equidistant around the second outer surface of the second tapered side wall; and
(c) nesting the second container inside the first container such that the first number of wedged elements are engaged with the second outer surface.

16. The method of claim 15, wherein in step (c), the first number of wedged elements breaks the seal between the nested first and second, allowing the first and second containers to be separated easily without the use of a tool.

17. (canceled)
